(19) United States
(12) Patent Application Publication
(10) Pub. No.: US 2012/0107476 A1
(43) Pub. Date: May 3, 2012

(54) COOKING APPARATUS AND METHOD OF ASSEMBLY AND USING

(75) Inventors: Don McLEMORE, Fortson, GA (US); Brian Urquhart, Columbus, GA (US); John D. McLemore, Fortson, GA (US)

(73) Assignee: Masterbuilt Manufacturing, Inc., Columbus, GA (US)

(21) Appl. No.: 12/938,031

(22) Filed: Nov. 2, 2010

(51) Int. Cl. A47J 27/00; A23L 1/01; A23L 1/315; B23P 17/04

(52) U.S. Cl. 426/523; 99/444; 29/428

(57) ABSTRACT

Cooking apparatus having a shell structure with a reception cavity and a base bottom. The base bottom includes an essentially solid funnel wall extending down and in toward a lower fluid outlet. A leg support assembly is secured to the shell structure and a holder device is positioned within a reception cavity of the shell structure. The holder device has an upper portion secured to the shell structure and a lower catch support portion. The food holder defines a food reception recess and a food holder base bottom. The food holder base bottom has an essentially solid, sloped wall extending down and in from a lower end portion of said main body portion. The food holder is supported in a state of suspension by the catch device and is configured with a lower portion that extends below the lower catch support portion and above an underlying region of the shell base bottom. A heating device extends into heat transfer proximity to the food holder.

### CROSS REFERENCE TO RELATED APPLICATION(S)

This application claims the benefit of U.S. Provisional Application No. 60/257,543 filed on Nov. 3, 2009, which Provisional Application is incorporated herein in its entirety.

### ILLUSTRATIVE FIELD OF INVENTIVE SUBJECT MATTER

Subject matter of the present invention includes a cooking apparatus in the form of an electric, outdoor cooker that is suited for roasting large food items such as a whole turkey, and, when used in such fashion, provides a cooker in the form of an “oil-free turkey fryer.”

### BACKGROUND DISCUSSION

Known in the art are outdoor, oil based turkey fryers such as those manufactured by Masterbuilt Manufacturing Inc. with reference being made to U.S. Pat. No. 6,711,992 as an example.

Examples of outdoor electric cooking apparatus are seen in the following patents or publications:

| | |
|---|---|
| U.S. Pat. No. 3,098,427 | Del Francis |
| U.S. Pat. No. 3,959,620 | Stephen, Jr. |
| U.S. Pat. No. 4,663,517 | Huff et al. |
| WO 98/44835 | Ragland |

Relative to the above-described oil based cooking apparatus suited for frying whole turkeys, in some settings and/or situations cooking with oil may not be desirable to a user.

### SUMMARY OF ILLUSTRATIVE INVENTIVE EMBODIMENTS

An embodiment of the invention provides an alternative cooking apparatus which allows for outdoor cooking (as well as indoor cooking with the same) of large food items such as a 10 to 18 pound whole turkey without reliance on oil as the cooking medium as well as indoor cooking. Thus, an embodiment of the invention includes, in essence, an oil-less turkey fryer.

An embodiment of the cooking apparatus comprises a shell structure with a main body portion having an interior surface defining a reception cavity and a shell structure base bottom. The shell structure base bottom includes an essentially solid sloped wall that tapers down and radially in toward a lower fluid drain aperture. A support device is secured to the shell structure and extends out a way from the shell structure. A holder device is positioned within the reception cavity of the shell structure, and the holder device has an upper portion secured to the shell structure and a lower catch support potion. Also a food holder is provided that has a main body portion with an interior structure defining a food reception recess and a food holder base bottom. The food holder base bottom includes an essentially solid, sloped wall extending down and radially in from a lower end portion of the main body portion. The food holder is supported in a state of suspension by the lower catch support portion and is configured as to have the food holder base bottom extend below the lower catch support portion and above an underlying region of the shell base bottom. The lower portion includes a fluid drain aperture. Further, there is provided a heating device which extends into heat transfer proximity to the food holder.

An embodiment of the cooking apparatus features each of the shell structure base bottom and food holder base bottom having a funnel or conical configuration leading to the respective drain apertures. The drain apertures are sufficiently aligned as to provide for fluid release from the food holder drain aperture to the shell structure base bottom, and then out the drain aperture of the shell structure base bottom.

An embodiment of the cooking apparatus has the slope of the sloped wall of the base bottom of the food holder at a value greater than the slope of the sloped wall of the base bottom of the shell structure.

An embodiment of the cooking apparatus further includes a drip receptacle and a drip receptacle suspension support assembly which positions the drip receptacle in a fluid catch relationship relation to the central drain apertures.

An embodiment of the cooking apparatus features the support device being a leg support device that comprises a plurality of legs secured to the shell structure, and the suspension support assembly has a plurality of suspension rods extending radially inward into a drip receptacle engagement device. The suspension rods are, in one embodiment, secured to an intermediate region of the legs and the engagement device includes a ring member in which the drip receptacle extends into a friction engagement relationship.

An embodiment of the cooking apparatus has the holder device comprising one or more ring members and a plurality of bar members secured to the one or more ring members in peripherally spaced fashion, and the lower catch support is defined by a lower one of the one or more ring members which defines a catch aperture through which the base bottom of the food holder extends.

An embodiment of the cooking apparatus features a heating device that includes an electrical heat resistance element that extends inward from the interior surface of said shell structure at a level essentially at or above the height of the drain aperture of said food holder.

An embodiment of the cooking apparatus features an outdoor cooking apparatus with the heating device being an electrical power heat device as in an electric resistance heating device.

An embodiment of the cooking apparatus features a food holder device in the form of a basket with a side wall of the basket defining the food holder main body and including an apertured upper region and an essentially non-apertured lower region extending peripherally about the lower end of the food holder main body and bordering the base bottom of the food holder.

An embodiment of the cooking apparatus has the shell structure comprising an outer shell and an inner liner defining a dead space region therebetween, and wherein the horizontal cross-section width of the dead space region expands and contracts in going axially along the shell structure, and wherein the inner liner has an upper flange that extends over an upper edge of the shell.

An embodiment of the cooking apparatus further includes a lid having a hook engagement device lid handle and where a fastener of the lid handle secures the hook engagement device which is configured for releasable engagement with the upper edge of the shell structure.

An embodiment of the cooking apparatus has the shell structure including an outer shell and an inner liner, the inner linear being slidingly received inside the outer shell and the inner liner having an upper flanged rim that extends over an upper edge of said outer shell. Also, the holder device having a cage-like structure with peripherally spaced bars with upper ends secured to the inner liner.

An embodiment of the cooking apparatus has the liner extending into contact with the base bottom of the shell and the shell structure including a first set of aligned apertures, respectively provided in the outer shell and inner liner, to receive the heating device.

An embodiment of the cooking apparatus has the holder device as a cage structure, and the lower catch support portion is defined by a lower ring of the cage structure and the cage structure includes peripherally spaced bars that each include, in a vertical sequence, a lower section which slopes up and radially away from the lower ring, a first corner region, and a more vertical intermediate section extending more vertically than the lower section, a second corner region, and an upper sloped region which extends obliquely out away from the second corner region, a third corner region, an uppermost more vertical section having a fastener component at an upper end region. Also, the food holder is a basket with the base bottom of the basket being secured by and extending past the lower ring, and the main body of the basket being received internally within the peripherally spaced bars.

An embodiment of the cooking apparatus further includes flavor importing tray device which includes a tray structure for receiving flavor inducing material that is positioned on or in close proximity to a heating component of said heating device. Also the shell structure has, in an embodiment, an outer shell wall and an interior liner wall with a clearance space therebetween, and the outer shell and interior liner have apertures that are aligned for receiving the tray device at a position in contact or in close proximity to a heating component of the heating device. The aperture in the outer shell has a lower edge providing below level support to the received flavor imparting tray device.

An embodiment of the cooking apparatus further includes a drip pan and a drip pan suspension assembly, the drip pan suspension assembly including a central ring member and a plurality of spoke suspension rods, each with an interior end adjustably engaged with the central ring member, and outer ends of the spoke suspension rods are secured to respective portions of the support structure, and the central ring member is sized to frictionally retain in position the drip pan.

An embodiment of the cooking apparatus further comprises a grill rack assembly that includes a grill rack sized for receipt within the food holder and a food support stand preferably adjustably and/or releasably secured to the grill rack. An embodiment features a grill rack that has a plurality of grill rods inclusive of capture member rods which include loop or bent regions. The food support stand includes a plurality of projections or hook members that extend into the loop regions as to releasably secure the food support stand to the grill rack, and the food support stand has a tapered configuration and a size designed for retention of a whole turkey on the food support stand (e.g., insertion of at least a majority of the stand into a cavity of the whole turkey and one embodiment preferably involving a full insertion or sufficient insertion such that a portion of the whole turkey rests on the grill rack).

An embodiment of the cooking apparatus has the food support stand comprising a plurality of support rods that are joined together at a common top region of the food support stands as to provide a flexing base region in the stand support rods (e.g., a spring bar flexing).

An embodiment of the cooking apparatus further comprises a flow imparting container or canister with the grill rack including an aperture positioned under the food support stand which receives the flavor imparting container, the flow imparting container extending up into a cavity defined by the food support stand above the level of the grill rack.

An embodiment of the cooking apparatus comprises a leg support structure, a shell structure supported by the leg support structure and comprising an inner liner and an outer shell and a clearance space therebetween. The shell structure having a base section that is tapered inward and downward and includes a drain hole in a lower region of the base section. Also, a suspension hanger, which includes a cage structure, is provided and has an upper region supported by the shell structure and a lower catch region. An electric heater element is received within the shell structure, and a basket is configured for reception within the suspension hanger, and the basket has a tapered bottom base with a drain aperture at a lower region of the bottom base which is received within the catch region of said suspension hanger. The drain aperture is thus positioned above the drain hole of the shell structure such that cooking fluid released through the bottom base of the basket is adapted for release through the drain hole in the shell structure. In addition a drip receptacle suspension assembly is provided and includes a drip receptacle and a suspension assembly which includes a suspended receptacle catch component and suspension members secured to the leg structure and which extend radially inward to the suspended receptacle catch component. The drip receptacle is configured for tool-less releasable retention by the suspended receptacle catch component and the drip receptacle has an upper opening positioned as to catch gravity induced cooking fluid drainage from the drain hole in the shell structure. The drip receptacle includes a pan or cup embodiment with a grasping handle extending radially out away for the receptacle catch component.

An embodiment of the cooking apparatus further comprises a grill rack assembly that includes a grill rack sized for receipt within the food holder and a food support stand. The grill rack having a plurality of grill rods inclusive of capture member rods which include loop regions. The food support stand includes a plurality of projections that extend into the loop regions as to releasably secure the food support stand to the grill rack, and the food support stand has a tapered configuration and a size designed for retention of a whole turkey on the food support stand.

An embodiment of the invention includes a method of using an above referenced embodiment of the cooking apparatus, which method includes positioning a whole turkey on the support stand, positioning the grill rack assembly in the basket, positioning the basket in the suspension hanger; positioning the shell structure in an outdoor setting, and heating the heating device so as to cook the whole turkey held on the grill rack assembly.

An embodiment of the invention includes a method of assembling an embodiment of the cooking apparatus referenced above, which method includes securing the leg structure to the shell structure; securing the suspension hanger to an interior surface of the shell structure, inserting the basket such that the bottom base is received by the suspension hanger, securing the heating device such that it extends into a bottom region of the shell structure and such that the bottom base of the basket is at a location essentially at or above a height level of the drain aperture in said bottom base of the basket, and securing the drip receptacle suspension assembly to the leg structure such that the drip receptacle has an opening aligned with a vertical axis extending through each of the drain aperture and the drain hole.

### BRIEF DESCRIPTION OF THE DRAWINGS

FIG. 1 shows a top front perspective view of an embodiment of the cooking apparatus from a left side orientation.

FIG. 2 shows an elevational view of the FIG. 1 embodiment from a right side orientation.

FIG. 3 shows an elevational view of the FIG. 1 embodiment from a left side orientation.

FIG. 4 shows a rear-left elevational view of the FIG. 1 embodiment.

FIG. 5 shows a rear-right elevational view of the FIG. 1 cooking apparatus embodiment.

FIG. 6 shows a top plan view of the FIG. 1 embodiment.

FIG. 7 shows a bottom-plan view of the FIG. 1 cooking apparatus embodiment.

FIG. 8 shows a partially exploded view of the FIG. 1 cooking apparatus with a cooking rack assembly and basket combination.

FIG. 9A shows a fully exploded view of the FIG. 1 cooking apparatus embodiment.

FIG. 9B shows a fully exploded view of an alternate embodiment similar to that of the FIG. 1 cooking apparatus embodiment but with an added vapor generator canister and corresponding food support rack.

FIG. 9C shows a partially exploded view of the FIG. 1 cooking apparatus with the cooking rack assembly (food support or stand and cooking rack combination) shown in basket cooking mode (but with the food item such as a whole turkey removed for added clarity) which basket is shown being grasped for removal (or insertion).

FIG. 10 shows a partially exploded view of the FIG. 1 cooking apparatus but with the cooking rack assembly having been removed to implement a basket alone cooking mode which basket is shown being grasped for removal (or insertion).

FIG. 11 shows a cut-away view of the cooking apparatus of FIG. 1 with the shell and inner liner cut away to provide an internal view of the cooking apparatus.

FIG. 12 shows even a further cut-away view of the cooking apparatus with the rack and basket combination in an inserted position and with the lid having been removed.

FIG. 12A shows a cross sectional view at cross-sectional x-x in FIG. 12.

FIG. 13 shows an additional cut-away view from a different orientation and with the basket being cut away to better appreciate the relative positioning of cooking rack assembly.

FIG. 14 shows an enlarged view of the smoker drawer assembly and receiving portion of the shell.

FIG. 15 shows a perspective view of the cooking rack assembly alone.

FIG. 16 shows a leg assembly step with the shell in an upside down orientation.

FIG. 17 shows a drip cup holder assembly step relative to the shell in an upside down orientation.

FIG. 18 shows a more detailed view of the control unit's panel.

FIG. 19 shows an insertion step for insertion of a whole turkey on to the food support stand (turkey stand in this instance) of the support rack assembly.

FIG. 20 shows a ready for cooking positioned turkey on a turkey stand.

FIG. 21 shows the lid in a removed, soon to be supported relationship relative to the shell.

### DETAILED DESCRIPTION

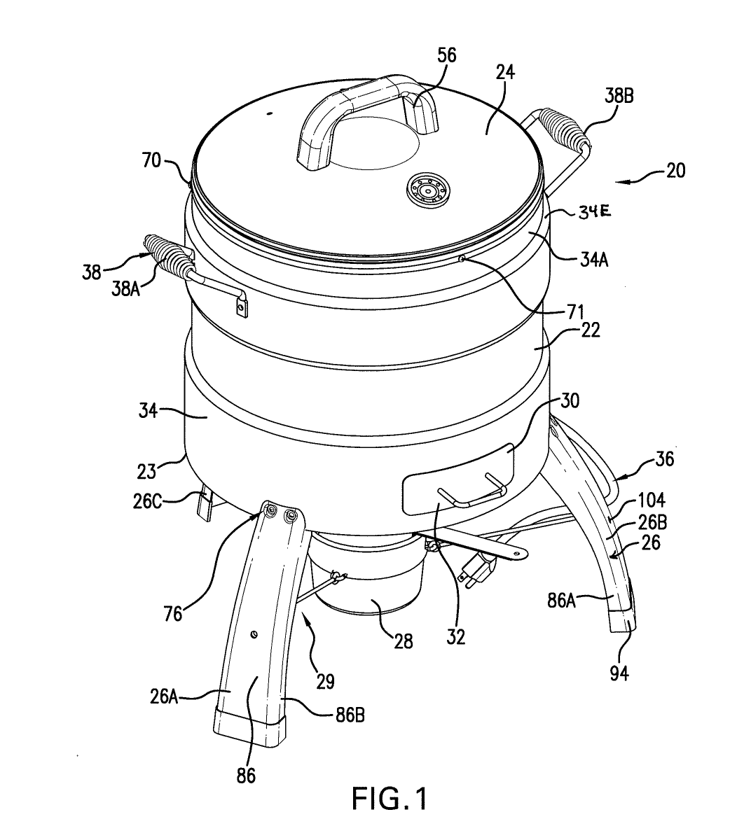

Cooking apparatus 20 is shown in FIG. 1 in a lid closed or cooking mode setting and includes outer shell 22 (or “shell”) covered with lid 24. Shell 22 is shown in a supported state above a support surface which is achieved by way of a support device 26 shown in this embodiment as comprising a plurality of support legs. Support legs 26 (three equally spaced legs 26A, 26B and 26C shown in this embodiment) also provide support to drip cup 28 (or drip can or receptacle) shown suspended below the outer, bottom edge 23 of shell 22 by way of drip cup holder device 29.

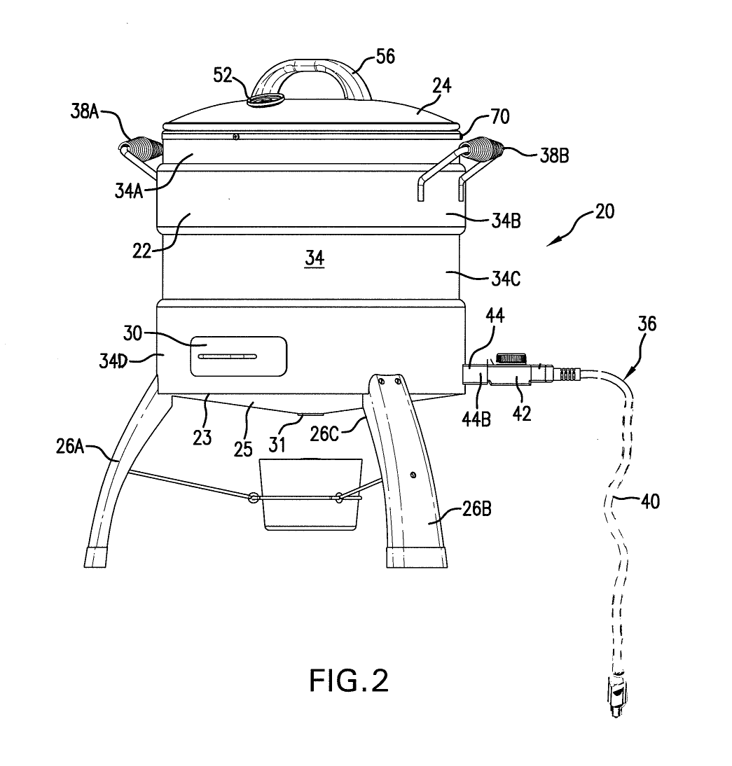

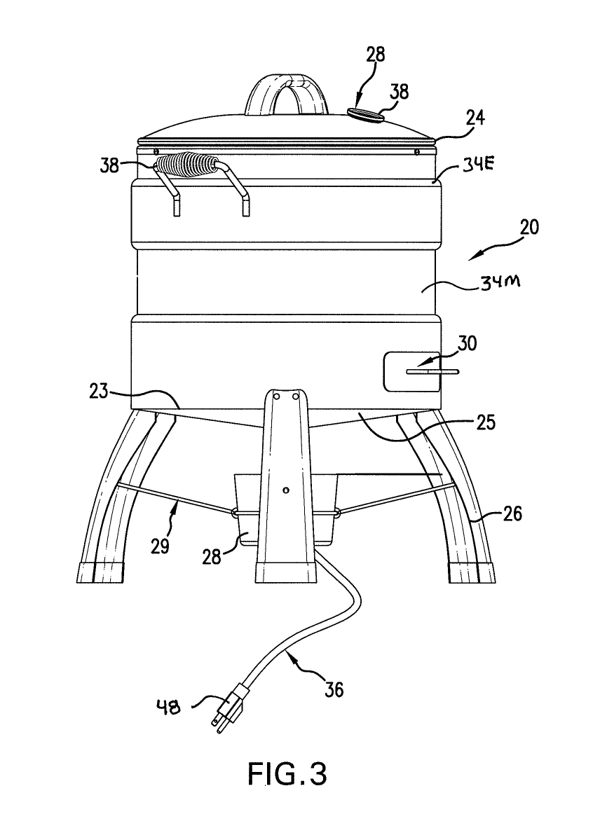

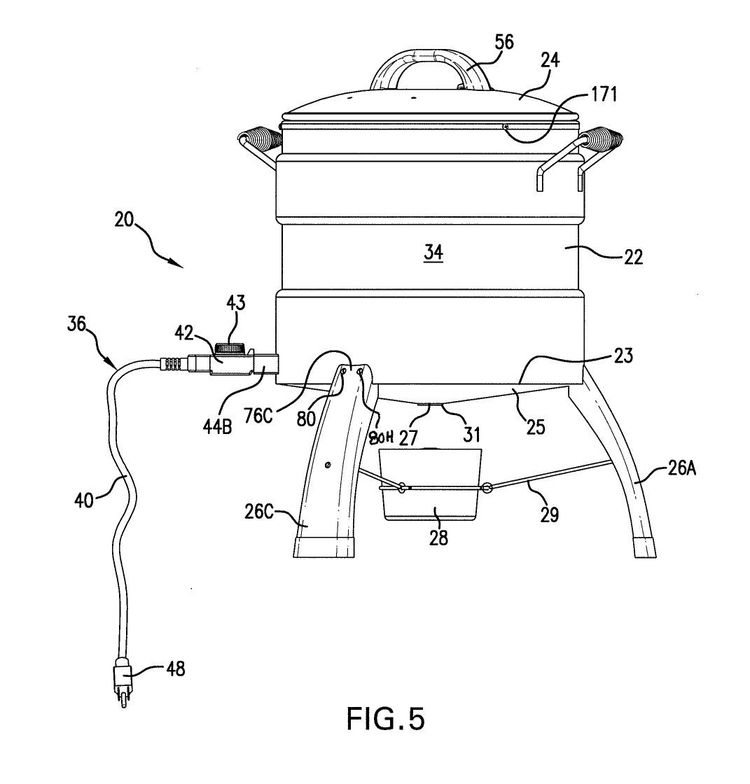

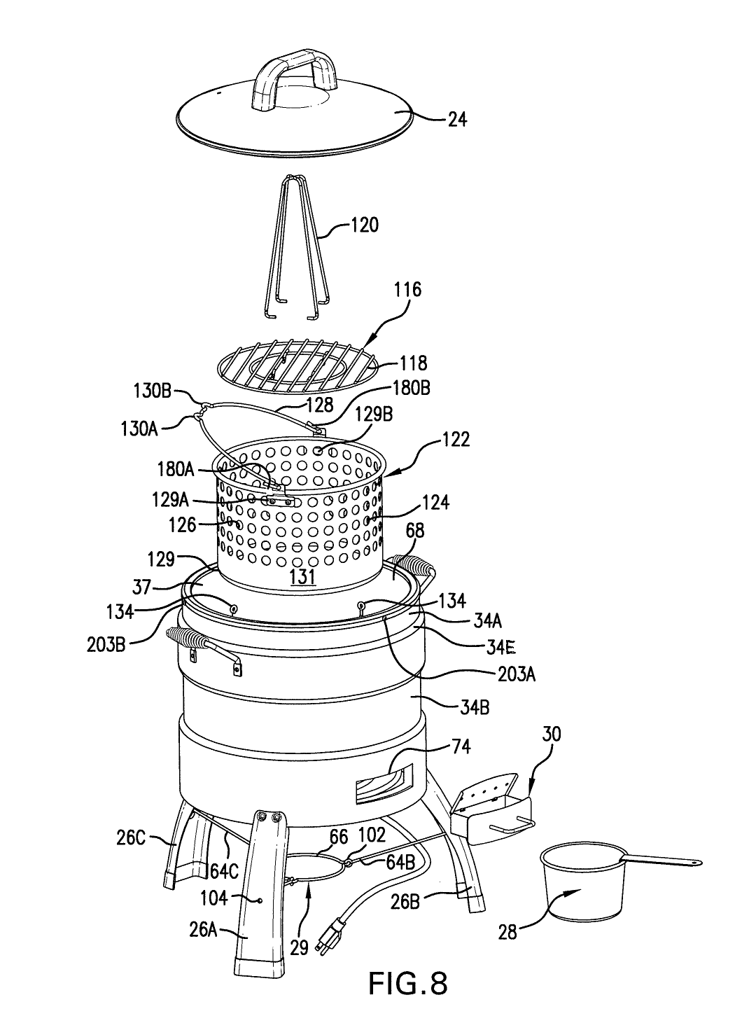

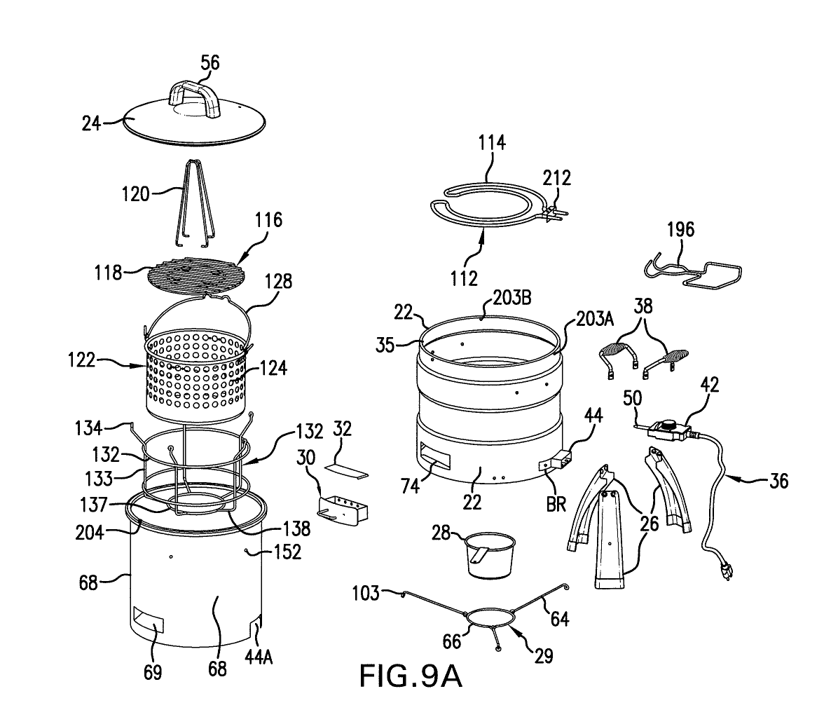

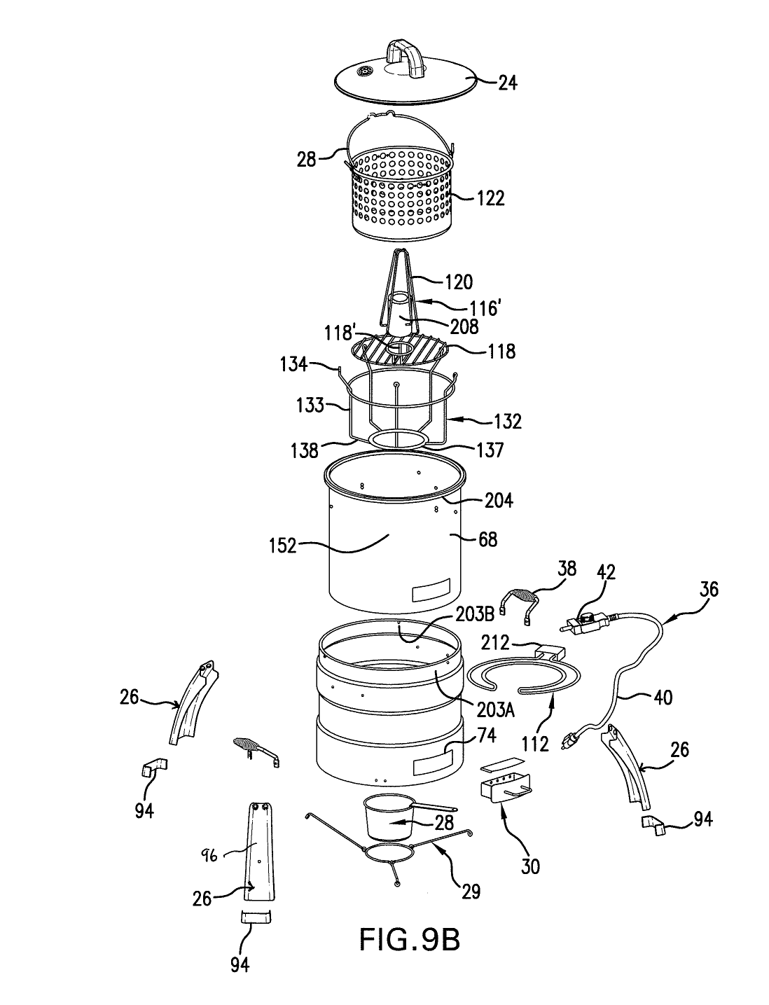

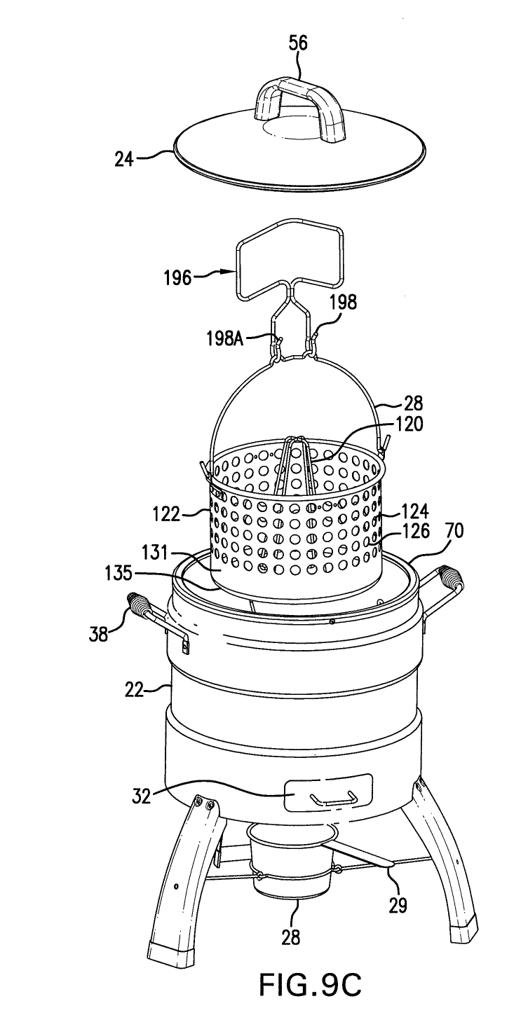

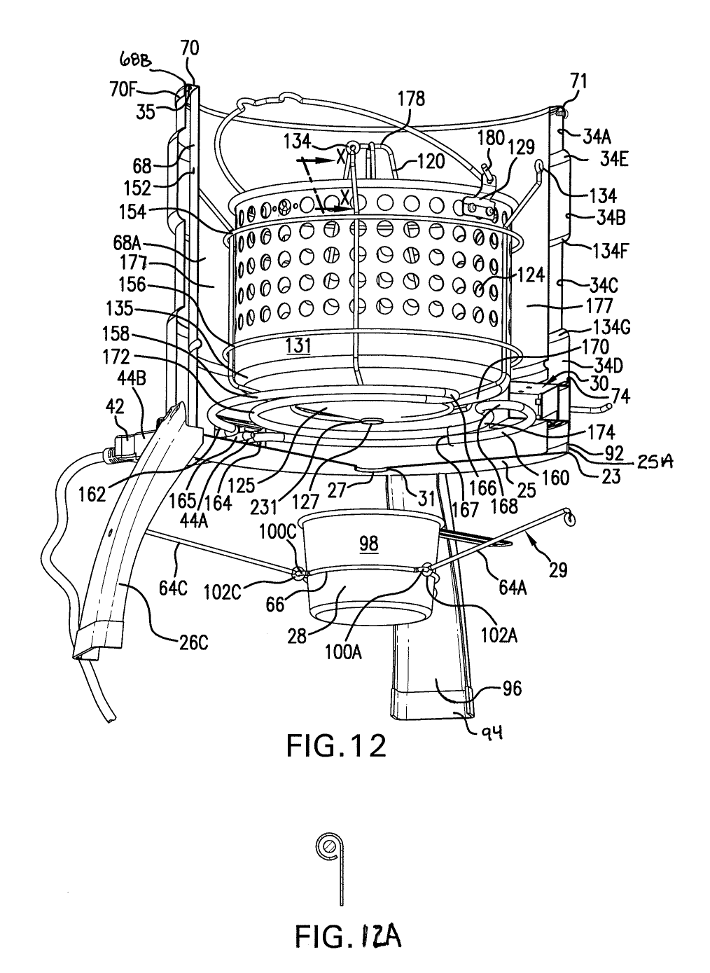

With reference to FIGS. 1-3 there can be seen that shell 22 includes main body 34M with exterior wall or shell surface 34. FIG. 9A further shows beaded (or L-shaped flange extension) upper rim edge 35 which is covered over by flange 70 of liner 68 when inserted. Rim edge 35 defines the upward facing open end 37 (FIG. 8) of shell 22 when lid 24 is removed. FIGS. 2 and 3 further show bottom base 25 of shell 22 which in the illustrated embodiment is shown as being conical or funnel shaped with an upper end coincident with outer bottom edge 23 and a main, solid body 25M tapering down and inward to outlet 27 shown as a central drip outlet at the lowest most portion of shell 22. As seen from FIGS. 5 and 12, outlet 27 is preferably defined by a lower, flange rim 31 extending down from a border region with bottom base main body 25M (e.g., an integrated bend edge at central outlet 27). The central axis of outlet 27 is also preferably aligned with the central axis of drip cup 28 when in its supported, suspended state via drip cup holder device or cup suspension means 29.

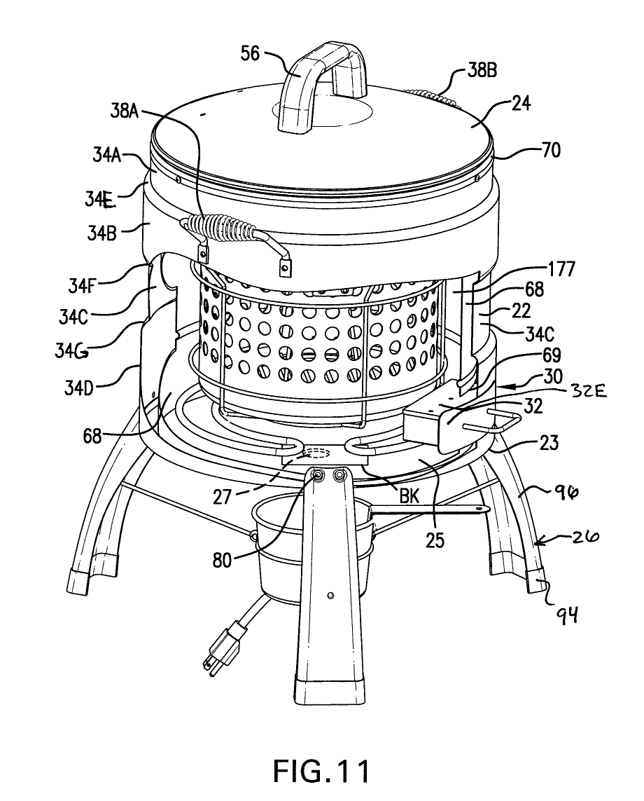

Shell 22 is also illustrated as having different diameter sections 34A, 34B, 34C and 34D forming a stepped sequence in exterior surface 34 (e.g., a unitary cylindrical shell body 34M that is configured such as by stamping to have the below described sections 34A, 34B, 34C and 34D). As shown in FIG. 11, in going from upper rim edge 35 down, there is seen first depressed (or smaller diameter) section 34A extending down to step edge 34E which extends radially out to form first projection (or larger diameter) section 34B. The lower edge of section 34B extends into second step edge 34F which extends radially inward to second depressed section 34C having a lower edge from which step edge 34G extends radially out to an upper edge of second projection section 34D which, in turn, extends down to a common diameter lower edge 23. The inner casing or liner 68 and outer shell combine together to define shell structure 18 which, in combination, is supported by leg structure 26.

As seen by FIG. 12, bottom base 25 preferably is provided with an upper flange section 25A which is secured (e.g., with securement means as in a weld, screw, bolt and nut combination, rivets, adhesive, combinations of the same, etc.) to the facing interior surface at the bottom end region 92 of shell main body 34M forming the bottom end region of second projection section 34D. Alternatively, bottom base 25 and main (cylindrical, stepped) body 34M can be formed as a monolithic body (one solid piece) as by molding.

As seen, for example, from FIGS. 1, 2 and 6, side handles 38 (38A and 38B) are secured in diametrically opposed fashion to first projection section 34B as by the above-described securement means such as a pair of pan head screw and nut sets for each side.

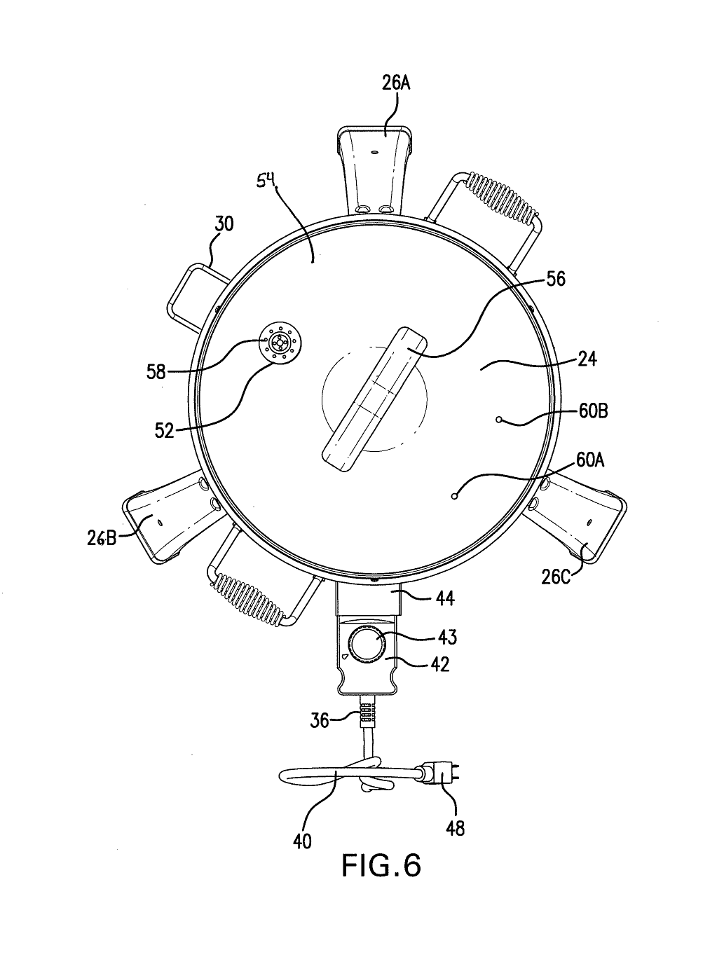

Second projection section 34D is further shown, as in FIGS. 6, 9A and 12, as having power cord reception means 44 positioned in an aperture defined by edging of the shell and which is also aligned with aperture 44A opening out at a bottom edge of liner 68. Reception means 44 also provides support to male/female casing 212 (FIG. 9B) which is sized for slide in insertion into projection 44B which, as seen by FIG. 9A, is secured by way of an opposite side screw bracket connector as in bracket BR of FIG. 9A (left side only shown) or by a weld or alternate securement means as in bolts or the like to shell 22. In this way projection 44B extends radially outward from shell main body and is aligned with the heating element reception aperture formed in the shell as well as the aligned aperture 44A formed in inner liner 68. Projection 44B is shown extending radially out from exterior surface 34 as at a location diametrically opposed to leg 26A (with flavor (or smoker in this embodiment) tray assembly 30 shown as being diametrically opposed to leg 26C). Projection 44B has a cavity for receiving power cord reception means 44 comprising casing 212 forming part of heating assembly 112 which receives the projection prong 50 of power cord control element 42 (thus providing a male/female telescoping electrical conveyance connection relationship between prong 50 of power cord control element 42 and heating element prongs 162 and 164 of heating element 114) as shown in FIG. 9A.

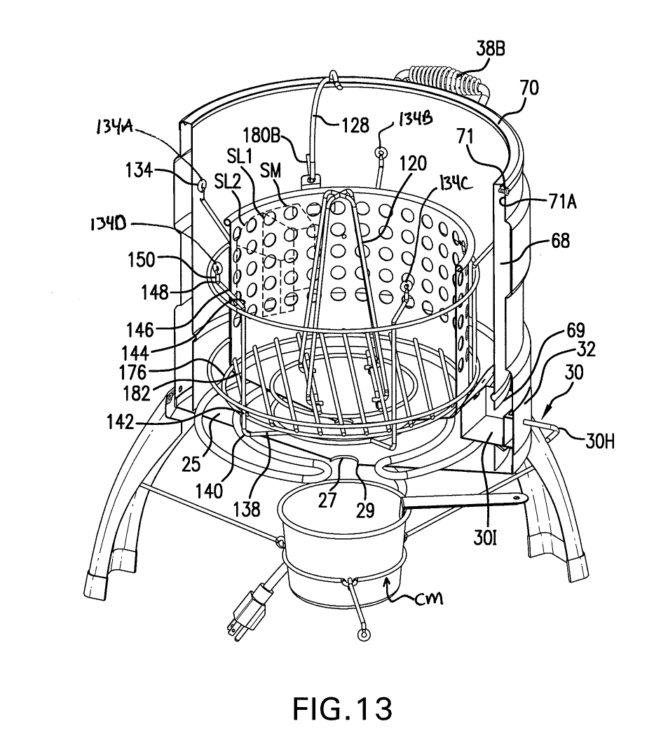

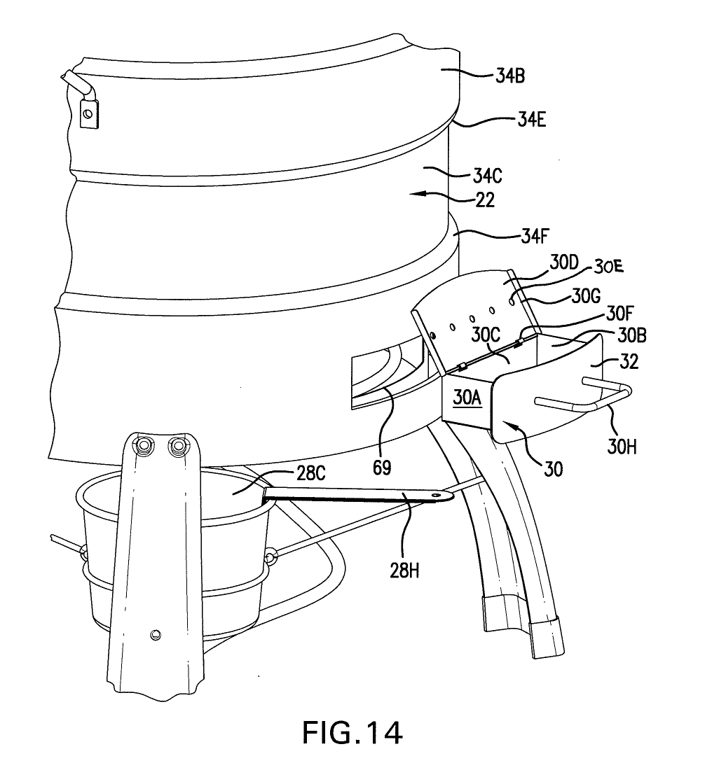

As shown in FIG. 8, shell section 34D further features tray assembly receptacle hole 74 receiving flavor material support assembly 30 shown as a tray assembly. Shell tray reception hole 74 (as well as liner 68 tray aperture 69) is shown configured to receive in sliding fashion and hold in position flavor material support assembly 30. As shown in FIG. 14, material support assembly 30 is preferably in the form of a tray assembly having a tray defined by outer presentment face 32, floor 30I (FIG. 13) and two radially extending sidewalls 30A and 30B and back wall 30C. Tray assembly 30 further includes an apertured lid 30D (with smoke passage apertures 30E formed in the lid and/or in one or more sections or walls for support of the material received in tray assembly 30), tray handle 30H, and hinged connector set 30F and side edge flange set 30G. Flavor material support assembly 30 provides a suitable storage location for smoke generating material as in wood material (e.g., chips, sawdust, etc) having a flavor imparting capability as in wood of hickory, mesquite, alder, pecan, maple, apple or cherry. Various other flavor imparting means as in other organic materials (liquid and/or solid) subject to smoking upon a certain heating temperature range (as provided by heating element 114) are also featured under the subject matter of the present invention. As further shown in FIG. 1, flavor material support assembly 30, which is in the form of a sliding tray assembly, has outer presentment face 32 with a configuration matching (e.g., common curvature) the exterior surface 34 of the receiving portion of shell 22. As shown in FIG. 12, tray assembly 30 is designed for cantilever extension in from its dual edge slide contact association with the receiving liner 68 and shell 22 apertures 69, 74. The radial interior end of tray assembly 30 is positioned close to (within an inch or two) or in contact with heating element 114.

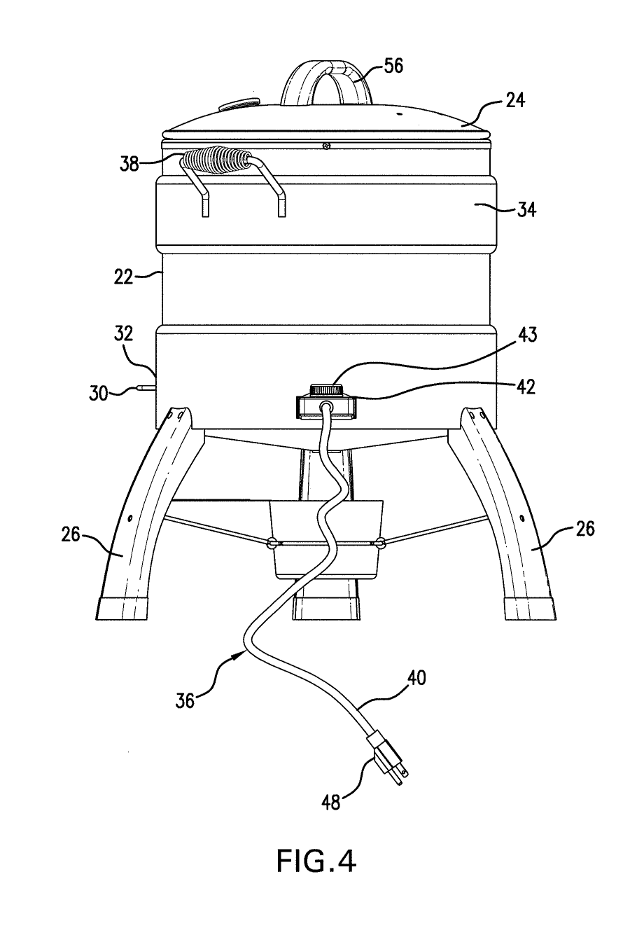

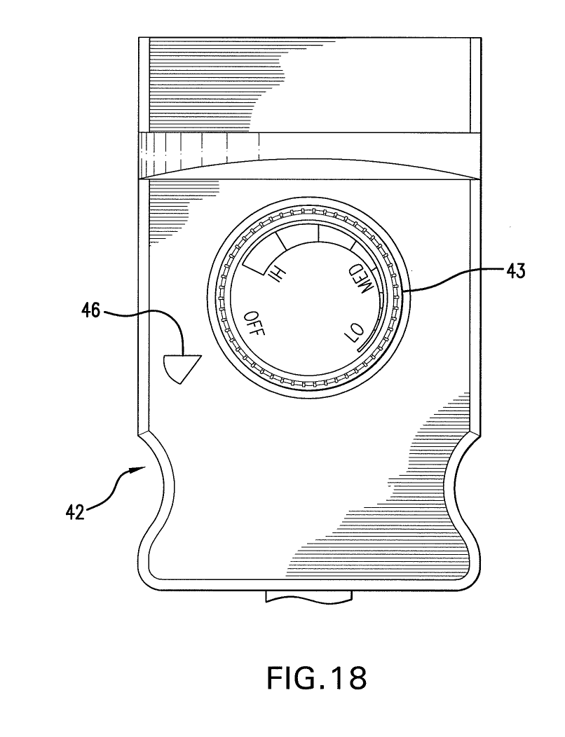

FIGS. 2, 4 and in greater detail FIG. 18, also illustrate control adjuster 43 of control unit 42 in the form of a finger grip temperature setting turn dial. FIG. 18 also illustrates the providing of setting indicator means 46 comprised in the illustrated embodiment of a marker (arrow head shown) combined with indicia showing an off setting as well as continuous level presenting indicia shown as comprising low, medium and high designations with color and/or configuration indicia therebetween to convey temperature level of the below described heating device (e.g., resistance heating element) 114 of heating assembly 112. Power cord 40 is shown with a typical electric outlet plug 48 at one end and a conducting plug projection 50 (FIG. 9A) extending out from control unit 42 and providing for male/female combination connection means.

FIG. 6 shows in top plan view cooking apparatus 20, and there can be seen the outer radial extension of legs 26A, 26B and 26C relative to their respective attachment regions to outer shell 22 in the bottom end region 92 of shell 22 forming the bottom end region of second projection section 34D. Also, in FIG. 6 there is seen in greater detail the male/female attachment relationship between receptor 44 and power cord device 36.

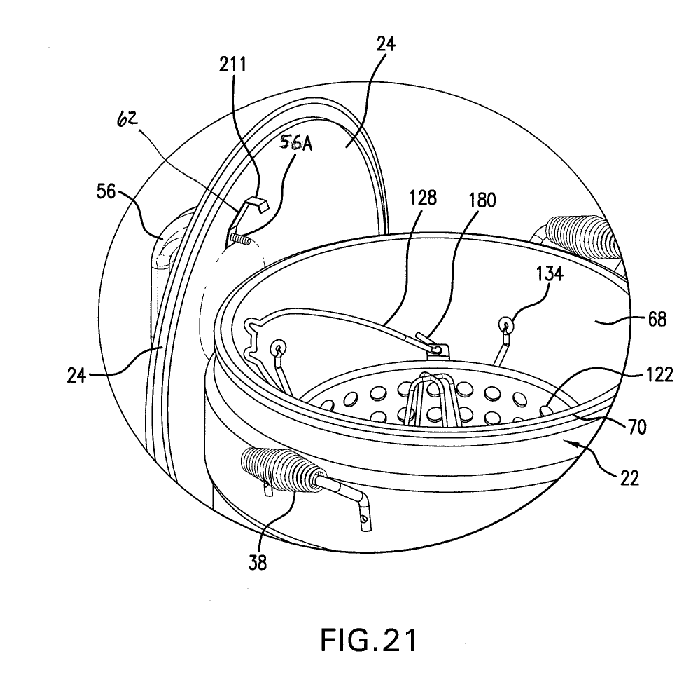

FIG. 6 also illustrates lid 24 having adjustable vent 52 in an intermediate circumferential region of outer lid surface 54 and lid handle 56 shown more radially centralized. To adjust the vent level in vent 52 there is provided pivoting louver 58 with associated finger catch. FIG. 6 further illustrates venting means 60 (as in vent holes 60A, 60B). At least one of the fasteners for handle 56 also preferably is used for securement of lid hanger 62 shown secured by way of an extension of fastener 56A (FIG. 21).

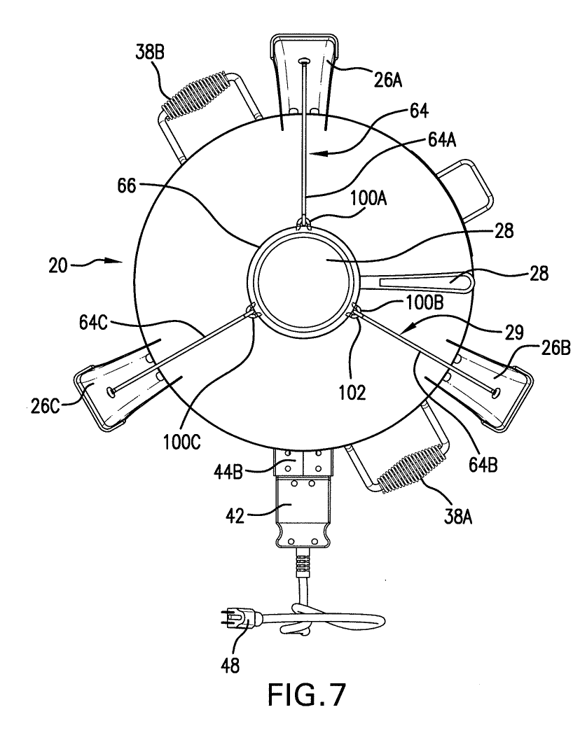

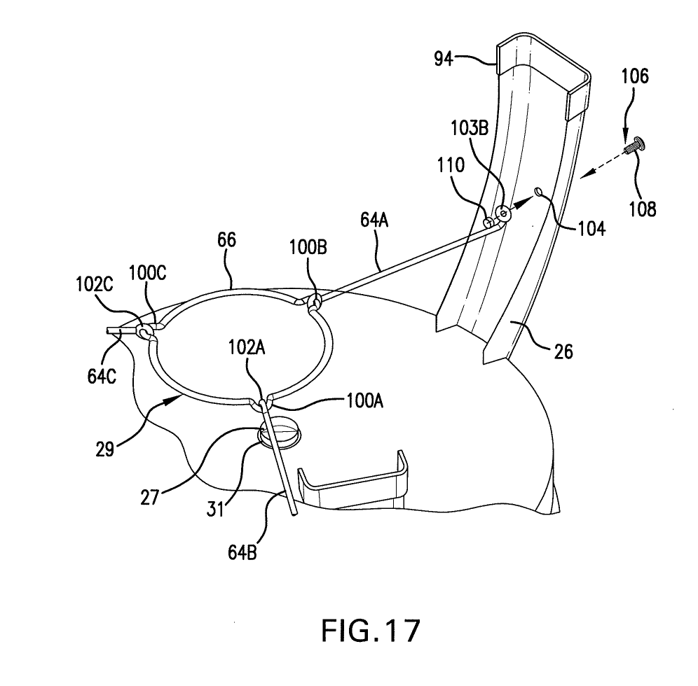

FIG. 7 provides a bottom plan view of cooking apparatus 20 wherein there can be seen in greater detail suspension means 64 as in suspension rods or spokes 64A, B, C. Also shown is suspension ring 66 which together with suspension rods 64A, B, C form drip cup holder device or assembly 29. With further reference to FIGS. 12 and 17 there can be seen that drip cup holder assembly 29 features a suspension ring 66 with an interior surface dimensioned to contact an intermediate region of a tapering side wall 98 of drip pan or cup 28 comprising cup body 28C and handle 28H. Suspension ring 66 also includes a plurality of radial engagement projections 100 (100A, B and C) shown as being C-shaped in cross section and to which are engaged respective radially interior looped ends 102 (102A, B and C) of the spokes 64A, B and C. As seen, looped ends 102 are preferably closed off and encircle a portion of projections 100 such that the spokes, when in storage mode, can be rotated to a common location on the central loop in keychain-like fashion.

An opposite end of projections 100 are also provided with loop ends (radially external) 103 (103A, B and C) which are shown as each including a closed loop end which is orientated at a vertical plane that is 90 degrees offset from that of loop ends 102. This orientation provides for a securement of loop ends 103 to respective legs 26A, B and C. A securement example of an exterior end 103 of spokes 64 is shown in FIG. 17 for one of the three suspension rods 64A to 64C although each is preferably joined in the same fashion. As seen in FIG. 17, legs 26A, 26B and 26C are each provided with an intermediate aperture 104 and a fastener 106 comprised of, for example, screw 108 and hex nut 110 for compressing loop end 102 between the hex nut 110 and interior surface of leg 26A. Once all spokes 64 are secured to the respective legs a suspended drip pan holder device 29 is provided which when combined with pan 28 provide drip capture assembly or fluid capture means CM.

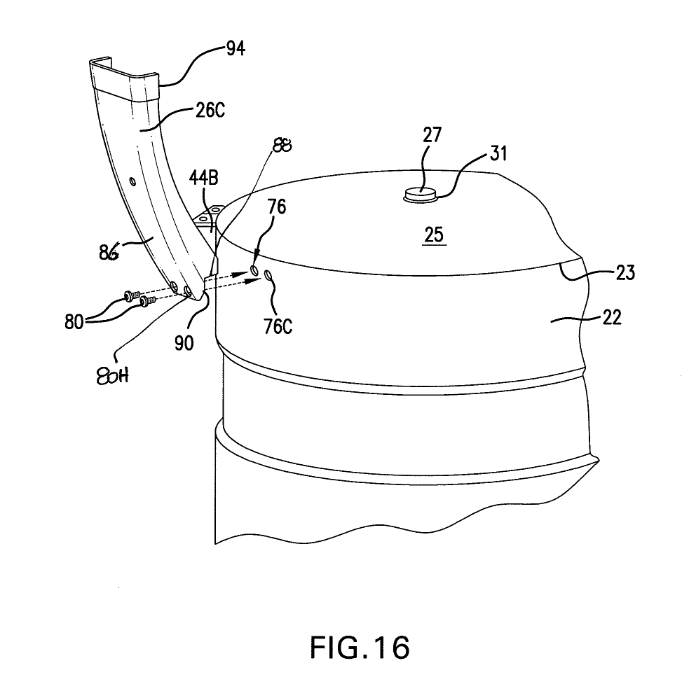

FIG. 16 illustrates a step of fastening (preferably preceding the above described spoke 64 attachment) of legs 26 to the base region 23 of shell 22. With reference to FIGS. 16 and 17 there is seen that each leg has at its upper end region an L-shaped cross-section for engagement with both the bottom exterior region of shell surface 23 and the bottom base 25 near edge 23 in shell 22. The radially inward extending portion of the L-shaped cross section of each leg end is positioned as to provide underlying contact support relative to bottom base of shell 25 (e.g., a common taper or sloping contact edge to bottom base 25 relationship). Also, provided in the lower annular region 22A of shell 22 are multiple pair sets of fastener holes 76 (76A, B, C) as in an embodiment such as that shown in FIGS. 9A, 9B and 16 featuring three pair sets for securement of respective support legs 26A, 26B and 26C. As shown in FIG. 12 each leg 26 has an upper region with a pair of securement holes 80H through which fasteners 80 (80A, 80B, 80C) arranged to extend through holes 76 in the base annular region 22A such that fastener sets 80 (e.g., a pair of screws or bolts with nuts or similar means for fastening 80A, 80B and 80C). In the illustrated embodiment of FIG. 1 three legs 26 are shown, alternate embodiments include one leg (e.g., a pedestal arrangement with hollow interior and a drip pin access door), two legs (as in legs with expanded bottom contact formations), three legs as described above, four legs (e.g., tapering out or true vertical support structures) as well as greater than four leg embodiments.

In the embodiment illustrated there are three legs 26 which are equally spaced circumferentially around shell bottom end region 23 as in 120° spacing. FIGS. 1, 9A, 9B and 12 further illustrate each leg comprising a C-shaped cross-section formed by an outer radially exterior wall 86 and two edge flanges 86A, 86B extending radially inward to opposite sides of wall 86. The radial length of the flanges increase in going from a lower region to an upper region of the leg and at the maximum radial extension point there is a step-in region 88 on each flange such that wall 86 has an extension 90 that is free of flanges and thus planar. At this location is provided the leg securement holes. Thus, as shown in FIGS. 12 and 13, upon securement of fasteners 80, each leg has a portion that extends radially inward of the outer edge of shell 22 and into contact with an undersurface 25 of the cup-shaped shell 22. At the bottom region of legs 26 there is provided surface contact members 94 shown as also having a C-shaped cross-section and designed for securement at the bottom end of main body structure 96 in each leg 26 (with FIG. 9A showing an exploded, detached state and FIG. 9B an attached state). An example for providing contact members 94 is dipping the ends of the main body 96 of a leg in a suitable liquid plastic or elastomeric material until solidification at the end (with or without an exterior surface defining mold). Alternatively, friction slide on, fastener secured, adhesion and/or securement means can be utilized.

FIG. 8 shows a partially exploded view while FIGS. 9A and 9B show different fully exploded views of cooking apparatus 20. FIG. 9A shows a similar embodiment as that shown in FIG. 9B but for the embodiment of FIG. 9B having a different component arrangement associated with its cooking rack assembly 116′ as compared to cooking rack assembly 116 in FIG. 9A. Cooking rack assembly 116′ is shown modified by way of having an added vapor generation canister 208 and a modified (central apertured) grill support 118′. Canister 208 is in the illustrated embodiment a flavor imparting vapor generator which features a container (e.g., metal can) with an open or openable top that is suited for insertion into a whole turkey cavity following neck and giblet bag removal together with stand 120. In an embodiment the canister 208 is sized for insertion into the interior of the rod assembly representing stand 120 and to be surrounded and generally radially retained by the cavity formed in modified grill support 118′ rack (e.g., insertion into a generally similar diametered central aperture). Canister 208 can include simply water for moisture purposes or a flavor imparting fluid and/or solid. An example of a suitable flavor imparting fluid which is vaporized upon cooking within the turkey inner cavity is apple juice, beer, although other flavor imparting means may be featured as in marinade sauces that are vaporized during cooking. Also, cavity 118′ can be sized to receive a standard beer can and provide a tip over preventing function while the base of the canister is supported by the underlying solid base of basket 122 in its position shown in FIG. 9C.

In addition, FIGS. 11 to 13 show cut-away views showing interior components of the cooking apparatus 20. This includes, for example, inner liner 68 which is dimensioned to be circumferentially surrounded by outer shell 22 and to have generally a common height as outer shell 22 with an extra flange suspension rim 70 preferably provided about the upper periphery of inner liner as to have shell 22 (in conjunction with legs 26) structurally support inner liner 68 once liner 68 is inserted into the interior of outer shell until peripheral suspension rim 70 catches on the upper edge 71 of bead 35 in outer shell 22. Once interior liner 68 is fully inserted into shell 22, tray aperture 69 and plug in receptacle hole 74A (e.g., a three sided slot) formed in interior liner 68 are circumferentially and vertically properly aligned with the corresponding shell tray reception aperture 74 in shell 22.

To provide for the desired shell 22 and liner 68 circumferential alignment and also preferably to provide for relative rotation prevention between shell 22 and liner 68 there is provided a multiple screw fastener connection arrangement 71 (or alternatively a projection and recess combination) as in one or more metal screw fasteners 71A (FIG. 13) supported by shell 22. In the embodiment illustrated multiple screws are supported by shell 22 and extend into corresponding apertures 203A and 203B (FIG. 8) provided in the flange area 70 of the liner (e.g., positioning screws that are received in corresponding holes 204 formed in outer vertical flange component 70F of the interior liner 68 and which are threaded or extend into corresponding holes in the shell to releasably lock the liner to the shell). While fastener screws are shown alternate upper region shell/liner rotation preclusion means are featured in alternate embodiments as in non-threaded male/female projection/recess combinations or the likes. Also, reliance can instead be placed alone on lower positioned engagements as provided by, for example, the aligned electrical plug and plug receptor.

Also, as seen from FIG. 12, for example, between the interior side of shell 22 and the exterior side of liner 68 there is provided a dead air space DS (FIG. 11) preferably extending all the way from bottom base 25 up to the overhang area at the mutual upper edges of liner 68 and shell 22. In this regard, as shown in FIG. 12 liner 68 is shown as having a main liner body 68A, an upper radial flange 70 comprising rim 68B and a peripherally outer downturn flange 68C which is designed to form a grasp support location relative to the upper peripheral end or bead 35 of shell 22. In an alternate embodiment a readily removable insulator body can be inserted as a separate step, although air alone is considered sufficient for illustrative embodiment of the inventions.

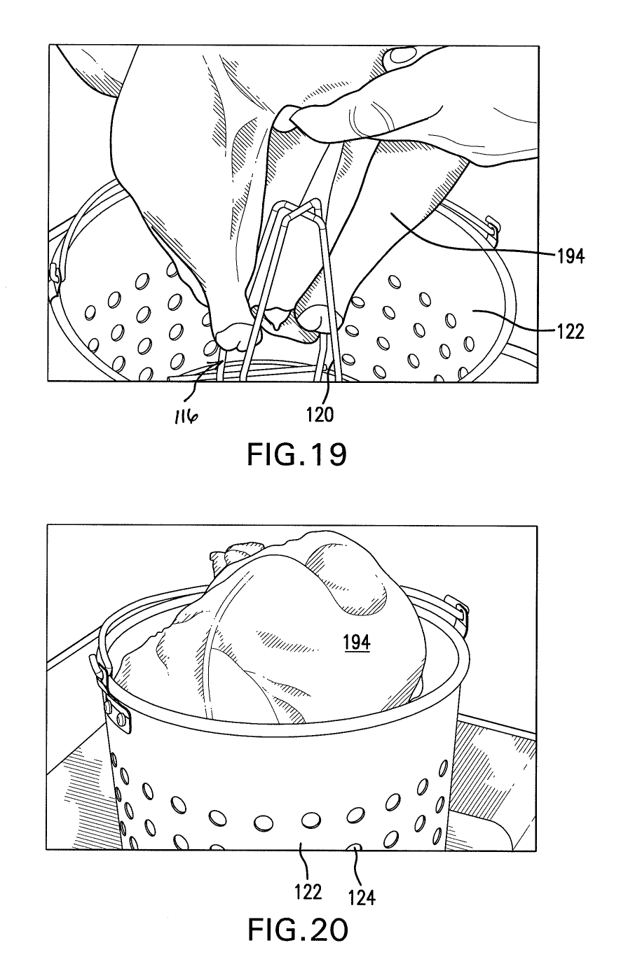

FIG. 8 shows some of the cooking apparatus interior components positioned below lid 24 when in cooking mode. This includes cooking rack assembly 116 comprising cooking rack 118 and food support stand 120 which in the embodiment shown is releasably attached to cooking rack 118 and extends upward and provides a support stand well suited for extension into a cavity of a food item such as a whole turkey or other food item as in a chicken or the like. In the embodiment shown, support stand 120 is dimensioned for insertion and retention within the cavity of a whole turkey such as one of 10 to 18 pounds (e.g., 12 to 14 pound) whole turkey. Stand 120 also extends over and around canister 208 in the FIG. 9B embodiment. Stand 120 is shown designed for whole turkey fixed support as shown in FIGS. 19 and 20. An embodiment includes a kit cooking rack assembly having different sized stands as in stands with a similar sized base for attachment with rack 118 but modified top region (e.g., curved in then out and then up and then back toward each other stand rods) as in a narrower circumference top region with less height for smaller poultry items as in chickens.

FIG. 8 further illustrates food support holder of food support means 122 which is shown in the form of a cooking basket comprising basket body 124 (with side positioned flow apertures 126), basket handle 128 and pivot mounts 129 (129A and 129B) receiving the free ends of the semi-circular bailing handle 126 with centralized, spaced grasp bump outs 130A and 130B. FIGS. 8, 9A, 9B further illustrates hanger 132, which in the embodiment shown is in the form of a basket hanger food holder suspension means. Hanger 132 is shown as having upper ends 134 (134A, B, C, D and E) preferably secured to the interior surface of inner sleeve or liner 68 with suitable fastening means as to provide a basket suspension function relative to the below lying heater 114 and further below lying bottom base 25.

Also, basket 122 is shown by breakout FIG. 12A as including a wire bead WB extending internally within a curled over upper edge UE of basket body 124 for added strength against shape deformation relative to large food item loads as in 10-18 lb turkeys.

As shown in FIG. 13, in an alternate embodiment there is provided supplemental food support means SM which is received within basket 122 (integral or a slide insertion in and out food support device). Support means SM is shown in dashed lines as an optional feature in this embodiment, and is shown as comprising a slotted compartment food organizer which is sized to receive other than a whole turkey as in vertically aligned ribs or steaks or even smaller individual piece food items such as shrimp, fries, etc. Food organizer SM is shown as including slot compartments S1 and S2 with two shown schematically as in a semi-circumferential holder (e.g., 30° circumferential extension), or a full 360° coverage annular ring holder by repeating the slot compartments as shown about the full circumference. Although not shown, suitable grasping handles as in a diametrically opposed set for a 360° food storage rack or a bailing handle arrangement such as that provided for basket 122.

As further shown in FIG. 12, basket body 124 has a solid non-apertured bottom base 125 that preferably extends down in a tapered manner (e.g., conical or funnel shape) such as in a relatively close to parallel relationship with the underlying tapered (e.g., conical or funnel shaped) surface represented by bottom base 25 of shell 22 (e.g., within 20° with the taper of the basket preferably being greater than that of the bottom base 25 of shell 22). As further seen, basket body 124 preferably also has a solid portion 131 that extends up from the bottom peripheral corner edge 135 from which the bottom base 125 initiates in its radial inward and downward extension, and from which portion 131 extends upward from. A taper of 10 to 20° (e.g., 15°) down from a horizontal plane in basket bottom base 125 is an example. There is preferably provided a lesser slope or taper range in shell bottom base 25 as in a 5 to 10° slope (e.g., 8°) down from a horizontal plane.

Also, the height of solid portion 131 is preferably sufficient to allow for some degree of fluid build up as might occur during a cooking cycle (e.g., natural food juices and oil that develop during the heat of cooking as in melted fat) prior to escape through an aperture 126. Thus, a 5 to 15% solid lower ring vertical height relative to a remaining 85% to 95% in the apertured remainder of the side wall height is an example. Also, the reference to solid bottom bases 125, 25 in the basket and shell leading to the respective drain apertures 127 and 27 is not meant to exclude some minor apertures or the like that generally don't significantly detract from the drain down and focusing of the drain flow exit to a desired location as in the drip pan 28. Alternatively, a fully apertured base in the shell or a non-apertured, sealed base in the shell bottom can be utilized as in one without a drainage cup feature or one with a commonly formed capture cup region in the shell base (as compared to, for example, the suspended drip cup assembly shown). Also, the basket, in alternate embodiments, can have a fully apertured base (e.g., in common with the apertured sidewalls shown) or a sealed bottom requiring post cooking drainage.

However, as illustrated in FIGS. 12 and 13, the solid bottom base 125 of basket body 124 preferably has a drain aperture as in the illustrated centralized aperture 127 shown at the lowest point of the bottom base 125 and shown as having a downwardly extending aperture defining flange 231. Also as seen in FIGS. 12 and 13, the central axis of aperture 127 is preferably coincident or generally aligned with the central axis of the aperture 27 formed in the shell bottom base 25. Also, the area (e.g., the diameter) of aperture 127 is preferably less than that of the underlying aperture 27 as to provide for some horizontal gravity flow deviation in a flow pattern in food sourced cooking fluid (e.g., cooking juices) exiting aperture 127 and extending through to the underlying aperture 27 in shell 22 and then into the also generally central axis aligned (and preferably even larger diameter) drip pan 28 lying (e.g., suspended) below shell bottom base 25 (and also preferably positioned below the lower edge of flange 31 in aperture 27).

FIGS. 9A and 9B as well as FIGS. 11 to 13 show hanger 132 (e.g., suspension hanger) in greater detail and, as seen, hanger 132 comprises a lower contact end 136 shown in the form of base ring 137 which has a smaller peripheral radial extension than other components of the hanger. For example, in the embodiment shown in FIG. 9A, hanger 132 includes a circular configured contact end or base ring 137 having a circumference positioned radially inward of the hanger's sidewall frame structure made up of circumferentially (or peripherally for non-circular embodiments) hanger bars 133. As shown, base ring 137 has a circumference extending about contact points on a common height portion of vertically extending hanger bars 133 (133A, B, C, D and E) which extend upward to free ends represented by upper ends 134. Each of hanger bars 133 is further shown as having a more horizontal than vertical extending lower section 138 extending both upward and outward away from a securement location with interior base ring 137 as well as a more vertical section 142 extending upward and preferably slightly outward up from a first corner section 140 at the outer end of section 138. Each of bars 133 is further shown as including an oblique extension 146 extending upward and outward (to a greater extent than section 142) relative to a second corner section 144 positioned at the upper end of section 142. There is further featured in each of bars 133 a generally vertically extending section 150 extending up from third corner section 148 positioned at the upper end of section 146. Each of sections 150 has a looped or hooked free end representing the aforementioned upper ends 134 (134A, B, C, D and E) which are secured to the interior surface of inner sleeve or liner 68 with suitable fastening means.

Securement of hangar 132 relative to liner 68 is preferably achieved by way of fasteners received by the looped ends 134 and extending through liner 168 (as in similar fashion to the previously described drip pan holder looped ends 102 (102A, B and C) and 103 of the spokes 64). As seen from FIG. 9B there is preferably featured fastener holes (screw holes) 152 strategically (e.g., equally circumferentially spaced) positioned in inner liner 68 as to provide for securement of hanger 132 in a desired location within liner 68 and shell 22 as by way of pan screws and bolt pairs.

Hanger 132 is further shown in this embodiment as having an upper rod contact ring 154 and lower rod contact ring 156. Upper contact ring 154 is shown as being secured (e.g., a weld) to each of hanger bars 133 at or about at third corner section 148. Lower contact ring 156 is positioned closer to first corner section 140 than third corner section 148 and preferably at a horizontal level that falls within an intermediate area of solid portion 131 when basket 122 is properly received in nesting fashion with hanger 132. As seen from FIG. 12, basket 122 has its concial base bottom 125 extending both above and below interior base ring 137 as it extends into the hole defined by base ring 137 in a direct contact with ring 137 suspension support or in a minor clearance fashion (based on the relative positioning of the below described lower sections 138 contact points). Peripheral corner edge 135 of basket main body 124 is shown as being in contact with hanger 132 at the border region between lower sections 138 and respective first corner sections 140 (e.g., on the lower curved corner portion of first corner section 140 or within an inch of the end of the lower end of that curved corner portion of section 140). Hanger 132 is shown in this embodiment as centering basket 122 when in its nested, suspended state within hanger 132. As seen, the lower portion of hanger 132 including base ring 137 and lower sections provide, in this embodiment, a catch device that engages with the food holder device or basket 122.

FIGS. 9A, 9B and 11-13 further illustrate the relationship between heating device (e.g., resistance heating element) 114 of heating assembly 112 and the remaining components of the cooking apparatus 20 including the relationship between the undersurface of the basket base bottom 125 and the heating device 114. Heating element is shown as being a resistance heating element with a C-shaped double loop configuration. That is, heating element features opposing first and second outer curved loop sections 158 and 160 which originate at respective ends of heating element prongs 162 and 164 which are shown as being generally straight sections extending out through the aperture formed in inner liner 68 and into electrical connection with a component of male/female projection 44B. FIG. 12 further illustrates temperature sensor 165 positioned between heating element prongs 162 and 164 and having a free end received within the interior cooking cavity within the liner 68.

Temperature sensor 165 senses the heat temperature being generated and sends the sensed temperature to a standard temperature control unit 42. Provided at the end of the outer loops 158 and 160 are sharper curved end regions 166 and 168 forming between them a clearance gap 170 of preferably less than 15% of a 360° perimeter extending along the exterior of loop sections 158 and 160 which is shown as having a circular circumference in the illustrated embodiment. Support bracket BK (e.g., a table shaped bracket that still allows for drainage down the tapered base) is shown extending up from shell bade 25 and into supporting contact with the end regions 166 and 168 as in a dual depression or yoke type reception arrangement relative to the heating element sections supported. There is further seen interior loop sections 172 and 174 extending from the radially interior ends of curved end regions 166 and 168 which together represent a C-shaped continuous element extension portion 167. Gap 170 is preferably positioned diametrically opposite the midpoint between prongs 162 and 164.

Heating element 114 is further shown as horizontally extending (preferably in a close but no contact relationship relative to the cage like hanger 132 and the bottom base 125 of basket 122). Also, with the conical configuration of basket bottom base 125, the upper end of heating element 114 can be moved close up to the basket's bottom surface. For example, a horizontal plane lying flush on the free edge flange 231 defining the drain aperture 127 in basket 122 is located either in common with the a horizontal plane bifurcating heating element 114 or above or below that bifurcating plane for a short length as in 2 inches or less and more preferably about 1 inch or less above of below that bifurcating plane. In addition to the resistive heating element other electrical based heating means 112 is featured in the present subject matter such as those operating in different electromagnetic radiation spectrum regions.

In addition, heating element 114 is further shown to be situated such that the periphery extending about the outer surface of outer loop sections 158 and 160 is positioned radially external to basket 22 and preferably also to hanger 132 (but relatively close thereto as within the interior side of a midpoint of the clearance space 177 between the interior of liner 68 and the circumferential location represented by ring 156). Interior heating element extension portion 167 is further shown as being positioned radially internally of ring 156 (and similarly radially internally of basket side wall in basket main body 124 with the apertures 126).

As further seen in FIG. 12, the level of end loops 134 (and liner apertures 152) is preferably about equal (e.g., at or within 1 or 2 inches as in less than 3 inch spacing above or below) to a horizontal plane lying flush on the upper free end 178 of food support stand 120. The position of the pivot point between pivot mounts 129 (129A and 129B) and the opposite hooked free ends 180 (180A, 180B) of basket handle 128 falls, relative to height, within the bumped out portion represented by shell section 34B (as preferably does the bar ends or fastener loops 134). When basket 122 is in its operational position within hanger 132 the grasping end of basket handle extends above radial flange 70 when in its vertical, ready for vertical pull out state.

As shown in FIGS. 8, 13 and 15 cooking rack assembly 116 comprises cooking rack 118 and food support stand 120. In the illustrated embodiment cooking rack 118 features a grate like body shown having an outer ring 176 (circular in the embodiment shown and matching the configuration of the receiving food holder 122) with different length grating rods 182 shown secured (e.g., welded) to ring 176 at their respective ends and positioned in spaced apart parallel fashion as to provide food support as well as stand support (when used) while still allowing for food source juices and the like to drip down the upper or interior surface of basket base bottom 125 and then down to the outlet aperture 127.

The periphery of outer ring 176 (or circumference for the illustrated circular outer ring) is shown as being just inward (e.g., less than 1 inch or less than ½ inch) of the interior surface of basket body 126 at about the upper initiation point for peripheral corner edge 135. Ring 176 is also shown as preferably being positioned below the grating rods 182 such that rack 118 is supported below by the contact of the ring 176 with the curved portion of corner edge 135 and/or the upper extremity of base bottom 125 and is shown as essentially fully occupying the basket interior at that horizontal height level of basket 122. A suspended relationship between ring 176 and the underlying basket bottom 125 is provided in one embodiment as where there is a height difference (e.g., within 1 to 3 inches in height spacing) between the lower, outer peripheral edge of basket main body 124 within the curved region 135 as at the upper edge of corner region 135.

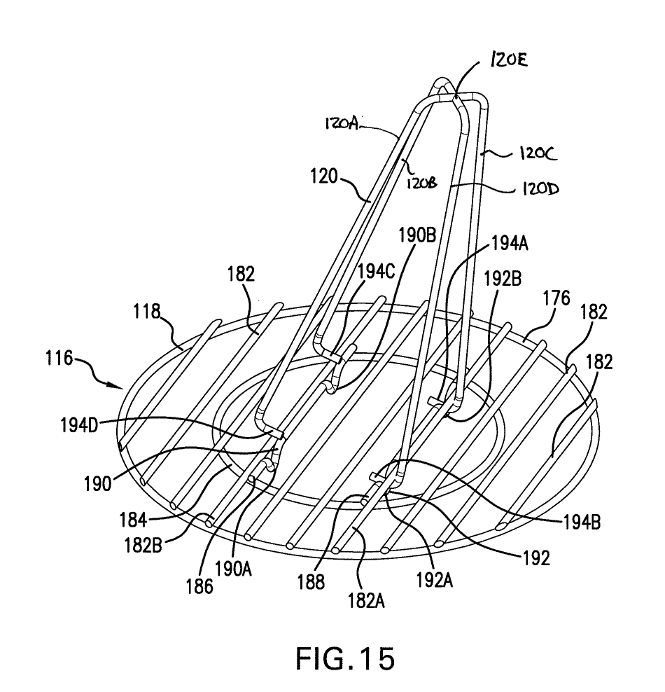

With reference to FIG. 15 there is seen cooking rack assembly 116 in greater detail. As seen, in addition to outer ring 176, cooking rack 118 further includes an inner ring 184 shown as being on the underside of grating rods 182 like outer ring 176 and at about a radial intermediate point between the center point of the circle representing outer ring 176 (which is preferably coincident with the vertical axis extending through the drain apertures 127 and 27) and the outer ring itself. Inner ring 184 is shown as being secured to a plurality of grating rods 182 as by a weld connection. Further illustrated in FIG. 15 are capture members 186 and 188 shown as being non-linear rods that are generally positioned on a common horizontal plane with grating rods 182 and are also shown secured to one or both of grating rods 182 and inner ring 184 as by welding. In the embodiment shown, capture members 186 or 188 are secured to inner ring 184 at their respective ends and/or with adjacent grating rods 182 positioned within the circumference of ring 184 as in an intermediate positioned rod between more central and less central grating rods. Also, capture members 186 and 188 have one or more (two shown) capture recesses 190 defined by concave bump-downs (190A,B) in rod 186 and a similar capture recess 192 as in set 192A, and 192B in rod 188.

As further seen in FIG. 15, capture recesses 190 and 192 extend just below the undersurface of respective grating rods 182A and 182B (e.g., the aforementioned adjacent grating rods) and to the interior or facing sides of those grating rods 182A and 182B. This provides for a position locking function relative to inserted hooked ends 194 (194A to D) of stand 120 with a first pair of hooked ends 194A and 194B being on a common side of stand 120 facing inward such that the interior curvature portion of the respective hooked ends 194A and 194B contacts the outer (radial outer relative to a diameter extending perpendicular to the grating rods 182 shown) surface of grating rod 182A and then extend under the grating rod 182A and into and past the recess defined by bump-downs 192A and 192B into a position locking relationship with cooking rack 118 as to present locking food support stand 120 and cooking rack 118. While the illustrated embodiment features a four bar food support stand 120 with respective locking hook lower ends, alternate embodiments include lesser hook/bar numbers as in a stand with three rods and hooks, or more than the four shown as in 5 to 8 rods, and corresponding end hooks, inclusive of one or more hooks extending radially outward in a direction other than perpendicular to rods 182 including parallel to the extension of the rods with suitable capture loops provided as in capture members and rack rods extending in perpendicular or criss-cross fashion relative to rods 182 and secured to inner ring 184 or those rods suitable locking loops for the hooked ends of the stand also being provided in those embodiments.

In FIG. 15 stand 120 is shown in a process state of being locked into its cooking position wherein the above noted hooked ends 194A and 194B on one side of stand 120 are locked in position already while the other pair of hooked ends 194C and 194D are shown in a close but not yet secured state (or in a just released state in a reversed removal process). Upon hooked ends 194C and 194D being positioned within capture recesses 190 defined by concave bump-downs (190A,B) the stand 120 is securely locked in a cooking mode position and suited for receiving a whole turkey 194 or the like for cooking via the heat generated by heating means 112. Preferably the stand members or rods 120A, 120B, 120C and 120D are formed of a common material and in a unitary single piece fashion and of a material that is flexible and biased back into its original shape in-spring bar fashion. Thus, as shown, bars 120A-120D have a common X-shaped top region 120E such that rods 120A-120D are unitary in nature.

In this regard, reference is made to FIG. 19 wherein there is illustrated cooking basket 122 shown as having been positioned away from shell 22 as on a countertop or the like (with suitable underlying fluid capture tray or the like in view of the open aperture 127 in basket 122) and having cooking rack assembly 116 being positioned in its cooking mode within basket 122. There is further shown in FIG. 19 the alignment of a central cavity in turkey 194 with the vertical extension direction of food support stand 120 during the initial preparation for cooking. FIG. 20 shows turkey 194 in its fully inserted position relative to stand 120 following pushing one or both into a telescoping relationship and in its cooking mode state relative to cooking basket 122. An illustrative whole turkey cooking size is one of 8 to 10 lbs. for example as in whole turkeys of 10 to 14 lbs. whole turkey.

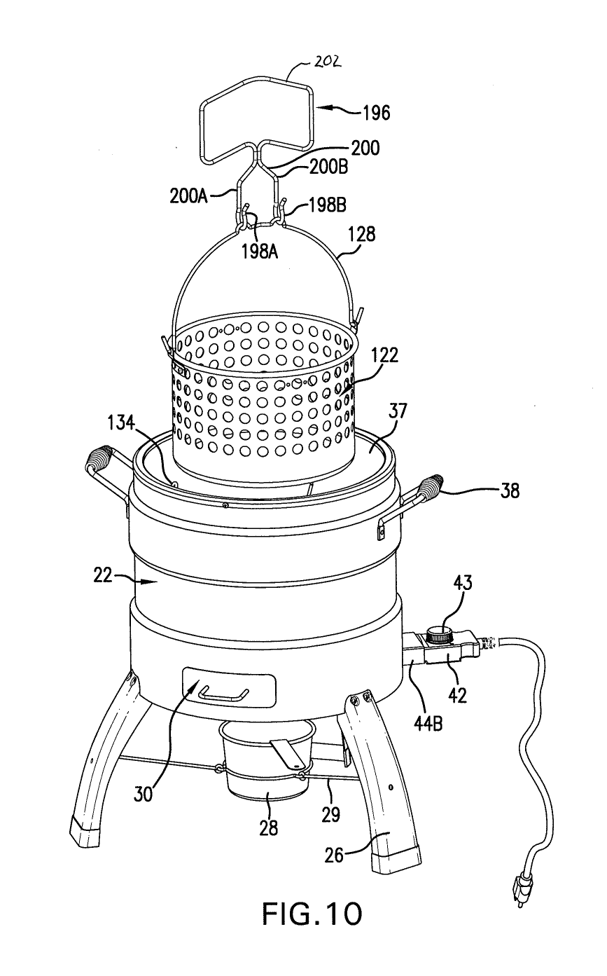

FIGS. 9C and 10 show food support grasping handle 196 shown in the form of a double lifting hook grasping handle having a pair of “S” shaped hook engagers 198A and 198B at the end of legs 200A and 200B of a Y-shaped extension 200 extending down from gripping section 202 shown as a handle loop. FIG. 9C shows a partially exploded view of the FIG. 1 cooking apparatus with the cooking rack assembly 116 shown in basket cooking mode as described above for FIGS. 19 and 20 but with the whole turkey removed for added clarity. Also, while FIG. 19 shows removal of the basket and placement of the turkey on stand 120 while the basket is removed, an alternate embodiment features positioning of the turkey on stand 120 while basket 120 is received within hanger 132. As seen in FIG. 9C basket 122 is shown being grasped for removal (or insertion) and again, a whole turkey would be positioned in contact with cooking rack assembly 116 or 116′, although not shown in this figure. Additional or alternative food can be positioned within basket 122 including use of added food compartments such as via food support means SM in FIG. 13 alone or in combination with stand 120 (e.g., food support means having a configuration that provides for simultaneous inclusion with stand 120 by way of, for example, common support on rack 118.

Thus, during a cooking preparation process following the preparation of the food item and positioning thereof in the cooking basket such as that shown in FIG. 19, the user can either hand carry based on a gripping of bailing handle 128 (due to the cooking pot and cooking apparatus being in a relatively cool state as it is prior to a cooking) or can rely on grasping handle 196 and its engagement via connection of hook engagers 198A and 198B with grasp bump outs 130A and 130B. Under either technique relative to a not yet heated cooking basket, the basket 122 is inserted until it is supported by hanger 132 as described above.

Preparation for cooking when including a generally external smoking or flavoring component also includes providing flavor or smoke generating material as in wood chips that have preferably been soaked in water to the smoker tray assembly 30. The tray of smoker tray assembly 30 is sized to receive about a cup of such wood chips and, once inserted, apertured lid 30D is closed and the tray assembly slid radially into the reception cavity 74 provided in shell 22 and the aligned aperture 69 formed in interior liner 68. As shown in FIG. 11, the smoke passage apertures 30E in tray assembly 30 are aligned to have the generated upward rising flavored smoke enter the generally sealed off clearance space 177 formed between the interior of liner 68 and the circumferential exterior of the apertured food support holder (e.g., basket) 122 and the upper lid 24. The generated smoke then encircles the food holder 122 and flows through apertures 126 in the basket so as to impart smoke to a 10 to 18 lb turkey situated on stand and/or other food supported food item(s) (e.g., vegetables situated on cooking rack 118 directly or in a separate storage compartment and surrounding the base to the turkey supported by stand 120 illustrating a combination of different food types being cooked in a common cooking cycle). Thus, with the cage like hanger 132 there is avoided flow disruptions relative to the smoke generated in clearance space 177 and passing through apertures 126 shown as being formed all the way around the side wall of basket main body 24.

FIG. 10 is illustrative of the insertion (or removal) of the cooking basket 122 free of cooking rack assembly 116 as may be the case when using cooking apparatus 20 for cooking other than a whole turkey (although cooking a whole turkey free of cooking rack assembly 116 or to 116′ is also featured under embodiments of the present invention). As shown the same equipment otherwise can be used to carry out such a cooking mode. An example being cooking a turkey breast (as opposed to cooking a whole turkey such as one on stand 120) with or without additional food components supported in basket 122 as in cut up vegetables or other poultry or fish or generally any of the food types suited for roasting.

FIG. 21 shows the underside of lid 24 having lid capture device 210 shown as including a hook member fastened to the underside of lid 24 by way of a fastener 56A that doubles as a fastener for one end of lid handle 56 (e.g., a pan head screw and bolt combination). The capture device 210 is shown in this embodiment as a hook member device 211 that is dimensioned as to provide for the lid suspension on the side of the shell via the hook device's outer flange extending down into the cavity 37 defined by the shell. Thus, a user can grasp lid handle 56 and orient the lid 24 such that the hook shaped capture device 210 can be slid down and extend over to opposite sides of flange 70 (FIG. 11). The length of fastener 56A is sufficient as to extend under flange 70 and in contact with shell upper end surface 34a as to provide a locking function together with hook member 211 to hold the lid in a generally vertical orientation and in locked relationship with shell 22. The basket can then be readily removed while the lid 24 is retained in an easily grasped location for closing off the cooking pot once the basket 122 is removed.

With reference to FIGS. 9A to 9C as well as FIGS. 16 and 17, there is described an assembly process method example for cooking apparatus 20. As seen by the exploded view shown in FIG. 9A, for example, legs 26 can come independent to the user (e.g., separate components in a boxed set of components for the cooking apparatus—with the leg tips 94 being pre-installed as by a dipping function or independent components to be installed by a purchasing user). Legs 26 are then assembled using suitable fasteners as described above for FIG. 16. The drip holder assembly 29 is then connected to the legs as described above for FIG. 17. A sequence of legs to shell and then drip holder assembly components to legs is preferred for operation stability, although a reverse sequence is also featured under the subject matter of the invention.

There is inserted into the shell, liner 68 such that both the smoker tray apertures and the heating device apertures are aligned (e.g., by having the alignment projections received in alignment cavities provided relative to the liner and shell). Once liner 68 is properly inserted into the shell, heating assembly 112 can be inserted as to have the casing 212 received within projection 44B with a tight slide relationship (e.g., elastomeric body contact) and/or fastener bracket connection used to hold the casing 212 radially stationary once inserted. After (or before in an alternate embodiment) heating assembly 112 is inserted, hanger 132 is inserted and fastened via the looped ends 134 as described above. Handles 38 are also connected at some point to shell 22 as to complete the assembly process. In this state, the basket 22 and smoker tray assembly 30 and power cord device 36 can be put in position in the manner described above to provide for a cooking operation. The basket 122 and optionally the cooking rack assembly 116 (following positioning of stand 120 as described above if utilized), grasping handle 196 and lid 24 are put into position or removed from position during the cooking operation and/or post cooking operations (each operation falling under a general “cooking operation” description) in accordance with the above-described functioning. Also, the above-described method steps (as well as below) are adjustable in sequence absent a specific order designation or a logic preclusion for a change in step sequence.

An example of a cooking operation includes (relative to an assembled cooking apparatus) the following:

A) providing food to the cooking rack or cooking rack assembly as in insertion of stand 120 into a cleared out cavity of a whole turkey of 10 to 18 lbs (e.g., 12 to 14 lbs);

B) placement of the cooking rack or cooking rack assembly and supported food item(s) into basket 122;

C1) placement of the food holder (e.g., cooking basket) within the liner and shell combination until reaching the bottom of suspension hanger 132 (with the step of food holder placement being carried out, for example, before or after placement of the cooking rack into the basket—and preferably after) and with or without the use of grasping handle 196;

C2) inclusion of a vapor generating canister if so utilized relative to modified rack assembly 116′.

D) plugging in power cord 36 (if not already plugged in);

E) insertion of the drip pan into drip pan holder (if not already in place);

F) wetting the flavor or smoker chips prior to cooking initiation (e.g., soaking for 30 minutes in water) if flavoring is to be provided generally external;

G) insertion of the drip tray with wetted wood chips so as to be internal of the outer surface of shell 22;

H) setting the control unit to a desired setting (temperature and/or heating time);

I) closing lid 24 to generally seal off the heat to be generated or being generated;

J) powering up the heater as in by plugging in the power cord and/or placing control unit 42 into a power up state;

K) cooking the food item(s) for a suitable time period based on time and heat level and/or with a food temperature gauge (e.g., a pop up internal food temperature gauge or other inserted temperature gauge or probe, preferably placed in position during the food preparation undertaken (as in the FIG. 20 position) prior to or after insertion of the food item(s) relative to the cooking rack or cooking rack assembly).

L) shutting off power after a suitable heating time as by control unit adjustment or pulling plug.

M) Lifting off lid 24 and optionally hooking lid to the side of shell as featured in FIG. 21;

N) Grasping the hot basket with handle 196 and raising the basket and food items to a suitable support location external to the shell as in a fluid receiving tray receptacle on a countertop (in view of the aperture 127—which is provided for a preferred embodiment although alternate embodiments include a solid bottom shell and basket and hence no drip pan);

O) removing food item from basket (either with or without cooking rack or cooking rack assembly)

P) removing one or more of the releasably secured components of the cooking apparatus as in more often subject to a cleaning cycle components that are made more readily removable such as the cooking basket, liner, cooking rack device, drain cup and lid and less often cleaning cycles for the heating element, support hanger and shell.

What is claimed is:

1. A cooking apparatus comprising:
a shell structure having a main body portion with an interior surface defining a reception cavity and a shell structure base bottom, said shell structure base bottom including an essentially solid sloped wall tapering down and in toward a lower fluid drain aperture;
a support device which is secured to said shell structure and extends out away from a bottom region of said shell structure;
a holder device which is positioned within the reception cavity of said shell structure, said holder device having an upper portion secured to said shell structure and a lower catch support portion;
a food holder having a main body portion with an interior structure defining a food reception recess and a food holder base bottom, said food holder base bottom including an essentially solid, sloped wall extending down and in from a lower end portion of said main body portion, said food holder being supported in a state of suspension by said lower catch support portion and being configured as to have the food holder base bottom extend below the lower catch support portion and above an underlying region of said shell base bottom, said base bottom of said food holder including a fluid drain aperture;
a heating device which extends into heat transfer proximity to said food holder.

2. The cooking apparatus of claim 1, wherein each of the shell structure base bottom and food holder base bottom have a conical configuration leading to said respective drain apertures, the drain apertures being sufficiently aligned as to provide for fluid release from said food holder drain aperture to the shell structure base bottom, and then out the drain aperture of said shell structure base bottom.

3. The cooking apparatus of claim 2, wherein the slope of the sloped wall of the base bottom of the food holder is greater than the slope of the sloped wall at of the base bottom of said shell structure.

4. The cooking apparatus of claim 2, further comprising a drip receptacle and a drip receptacle suspension support assembly which positions the drip receptacle in a fluid catch relationship relation to said central drain apertures.

5. The cooking apparatus of claim 4, wherein said support device is a leg support device comprising a plurality of legs secured to said shell structure, and said suspension support assembly has a plurality of suspension rods extending radially inward into a drip receptacle engagement device.

6. The cooking apparatus of claim 5, wherein said suspension rods are secured to an intermediate region of said legs and said engagement device includes a ring member in which said drip receptacle extends into a friction engagement relationship.

7. The cooking apparatus of claim 1, wherein said holder device comprises one or more ring members and a plurality of bar members secured to said one or more ring members in peripherally spaced fashion, and said lower catch support portion being defined by a lower one of said one or more ring members which defines a catch aperture through which the base bottom of said food holder extends.

8. The cooking apparatus of claim 1, wherein said heating device is an electrical heat resistance element that extends inward from the interior surface of said shell structure at a level essentially at or above the height of the drain aperture of said food holder.

9. The cooking apparatus of claim 1, wherein said cooking apparatus is an outdoor cooking apparatus and said heating device is an electrical power heat device.

10. The apparatus of claim 1, wherein said food holder device is a basket with a side wall of said basket defining the food holder main body and including an apertured upper region and an essentially non-apertured lower region extending peripherally about the lower end of the food holder main body and bordering the base bottom of said food holder.

11. The cooking apparatus of claim 1, wherein said shell structure comprises an outer shell and an inner liner defining a dead space region therebetween and wherein the horizontal cross-section width of the dead space region expands and contracts in going axially along the shell structure, and wherein said inner liner has an upper flange that extends over an upper edge of the shell.

12. The cooking apparatus of claim 1, further comprising a lid having a hook engagement device lid handle and where a fastener of the lid handle secures said hook engagement device which is configured for releasable engagement with the upper edge of the shell structure.

13. The cooking apparatus of claim 1, wherein said shell structure includes an outer shell and an inner liner, the inner liner being slidingly received inside the outer shell and the inner liner having an upper flanged rim that extends over an upper edge of said outer shell, said holder device having a cage-like structure with peripherally spaced bars with upper ends secured to the inner liner.

14. The cooking apparatus of claim 13, wherein said liner extends into contact with the base bottom of the shell and said shell structure includes a first set of aligned apertures respectively provided in said outer shell and inner liner to receive the heating device.

15. The cooking apparatus of claim 1, wherein said holder device has a cage structure, and said lower catch support portion is defined by a lower ring of said cage structure and said cage structure includes peripherally spaced bars the each include, in vertical sequence, a lower section which slopes up and radially away from the lower ring a first corner region, and a more vertical intermediate section extending more vertically than said lower section, a second corner region, and an upper sloped region which extends obliquely out away from said second corner region, a third corner region, an uppermost more vertical section having a fastener component at an upper end region, and said food holder is a basket with the base bottom of the basket being secured by and extending past the lower ring, and the main body of the basket being received internally within the peripherally spaced bars.

16. The cooking apparatus of claim 1, further comprising a flavor impacting device tray which includes a tray structure for receiving flavor inducing material that is positioned on or in close proximity to a heating component of said heating device.

17. The cooking apparatus of claim 16, wherein the said shell structure has an outer shell wall and an interior liner wall with a clearance space therebetween, and said outer shell and interior liner have apertures that are aligned for receiving said tray device at a position in contact or in close proximity to a heating component of said heating device and the aperture in said outer shell having a lower edge providing below support to the received tray device.

18. The cooking apparatus of claim 1, further comprising a drip pan and a drip pan suspension assembly, said drip pan suspension assembly including a central ring member and a plurality of spoke suspension rods, each with an interior end adjustably engaged with the central ring member, and outer ends of said spoke suspension rods being secured to respective portions of said support structure, and said central ring member being sized to frictionally retain in position the drip pan.

19. The cooking apparatus of claim 1, further comprising a grill rack assembly that includes a grill rack sized for receipt within the food holder and a food support stand, said grill rack having a plurality of grill rods inclusive of capture member rods which include loop regions, said food support stand including a plurality of projections that extend into said loop regions as to releasably secure said food support stand to said grill rack, and said food support stand having a tapered configuration and a size designed for retention of a whole turkey on said food support stand.

20. The cooking apparatus of claim 19, wherein said food support stand comprises a plurality of support rods that are joined together at a common top region of said food support stand as to provide a flexing base region in said stand support rods.

21. The cooking apparatus rack assembly of claim 19, further comprising a flavor imparting container and said grill rack includes an aperture positioned under the food support stand which receives the flavor imparting container, the flavor imparting container extending up into a cavity defined by said food support stand above the level of the grill rack.

22. A cooking apparatus comprising:
a leg support structure;
a shell structure supported by said leg support structure and comprising an inner liner and an outer shell and a clearance space therebetween, said shell structure having a base section that is tapered inward and downward and includes a drain hole in a lower region of said base section;
a suspension hanger which includes a cage structure having an upper region supported by said shell structure and a lower catch region;
an electric heater element received within said shell structure;
a basket which is configured for reception within said suspension hanger, and said basket having a tapered bottom base with a drain aperture at a lower region of said bottom base which is received within said catch region of said suspension hanger; said drain aperture being positioned above the drain hole of said shell structure such that cooking fluid released through the bottom base of said basket is adapted for release through the drain hole in said shell structure;
a drip receptacle suspension assembly comprising a drip receptacle and a suspension assembly which includes a suspended receptacle catch component and suspension members secured to said leg structure and extending radially inward to the suspended receptacle catch component, and said drip receptacle being configured for tool less releasable retention by said suspended receptacle catch component, said drip receptacle having an upper opening positioned as to catch gravity induced cooking fluid drainage from the drain hole in said shell structure.

23. The cooking apparatus of claim 22, further comprising a grill rack assembly that includes a grill rack sized for receipt within the food holder and a food support stand, said grill rack having a plurality of grill rods inclusive of capture member rods which include loop regions, said food support stand including a plurality of projections that extend into said loop regions as to releasably secure said food support stand to said grill rack, and said food support stand having a tapered configuration and a size designed for retention of a whole turkey on said food support stand.

24. A method of using the cooking apparatus of claim 23 comprising: positioning a whole turkey on said support stand;
positioning said grill rack assembly in said basket;
positioning said basket in the suspension hanger;
positioning said shell structure in an outdoor setting; and
heating the heating device so as to cook the whole turkey held on said grill rack assembly.

25. A method of assembling the cooking apparatus of claim 22, comprising:
securing said leg structure to said shell structure;
securing said suspension hanger to an interior surface of said shell structure;
inserting said basket such that the bottom base is received by said suspension hanger;
securing said heating device such that it extends into a bottom region of said shell structure and such that the bottom base of said basket is at a location essentially at or above a height level of the drain aperture in said bottom base of said basket; and
securing said drip receptacle suspension assembly to said leg structure such that the drip receptacle has an opening aligned with a vertical axis extending through each of the drain aperture and the drain hole.
